(19) United States
(12) Patent Application Publication
(10) Pub. No.: US 2002/0184002 A1
(43) Pub. Date: Dec. 5, 2002

(54) Method and apparatus for tailoring voice prompts of an interactive voice response system

(75) Inventor: Doreen Lynn Galli, Smyrna, GA (US)

Correspondence Address: David R. Irvin, IBM Corporation T81/503, PO Box 12195, Research Triangle Park, NC, 27709, US

(73) Assignee: International Business Machines Corporation, Armonk, NY (US)

(21) Appl. No.: 09/870,223

(22) Filed: May 30, 2001

(51) Int. Cl. G06F 17/28

(52) U.S. Cl. 704/7; 704/8

(57) ABSTRACT

An interactive voice response (IVR) system includes a database holding a library of pre-recorded voice prompts that have various specific contents determined by their purposes, as well as various language choices, speaker accents, degrees of formality, and so forth. The database entries are held outside the complied code of an application program that provides call flow instructions that direct the functional operation of the IVR system. When the application program requires a voice prompt, it selects a record of the database by passing a metalanguage variable to an assignment table that is also held outside the compiled code of the application program. The assignment table assigns a particular value to the meta language variable. The value of the metalanguage variable specifies the entry point into the database for recalling the database record which contains the desired voice prompt.

### FIELD OF THE INVENTION

The present invention relates generally to the field of telephone communication systems, and more particularly to a method for conveniently tailoring the vocal, dialect, and linguistic characteristics of voice prompts of an interactive voice response telephone system.

### BACKGROUND

A telephone user may call a business such as a bank, a professional's office, a retail merchant, and so forth, and reach an interactive voice response (IVR) system. The IVR typically guides the caller through a series of options according to a predetermined call-flow script.

For example, an IVR system that serves a bank's customers might greet each incoming caller, and, using spoken voice prompts, present a list of options to the caller. These options might include “press 1 to check your account balance, press 2 to transfer funds, or press enter or pound sign to talk with a customer-service representative.” Once the caller indicates a choice, the IVR system retrieves the requested information and presents it to the caller, or presents further options for how the call should proceed. For example, a caller who first selected the check-your-account option might next be presented with options that included “press 1 for the balance of your savings account, press 2 for the balance of your checking account, or press 3 for your available line of credit.”

Such IVR systems may be employed by businesses with national or international scope. To improve customer relations in such situations, the business may want to tailor the vocal, dialect, or linguistic characteristics of voice prompts that are spoken by the IVR system according to local demographics or according to other management preferences. For example, a bank with a national clientele might prefer to greet callers from major metropolitan financial centers with one degree of formality, whereas the bank might prefer to greet callers from rural areas or retirement communities with a different degree of formality.

Tailoring the characteristics of IVR voice prompts requires, however, the skill of a specialized programmer. As a consequence, IVR voice prompts cannot be altered ad hoc by personnel who lack the specialized skill of the IVR programmer. This means that an established business with an established IVR system may sometimes be unable to tailor its IVR voice prompts in order to adapt to the opening of new markets or to changing local conditions in a timely, convenient, and inexpensive way.

Thus there is a need for a method that enables administrative personnel who lack specialized IVR system programming skills to tailor the IVR voice prompts in a convenient way, so that a business that relies on an IVR may optimize the characteristics of the IVR voice prompts according to local demographics or according to other management preferences.

### SUMMARY OF THE INVENTION

The present invention provides an efficient method and apparatus that enable an administrator to tailor the vocal, dialect, and linguistic characteristics of voice prompts of an interactive voice response (IVR) telephone system. The inventive method and apparatus do not require the administrator to have specialized IVR system programming skills.

According to the present invention, a database holds a library of pre-recorded voice prompts that apply to a variety of applications. Various prompts have various specific contents determined by their purposes, as well as various language choices, speaker accents and other voice characteristics, degrees of formality, and so forth. The database entries are held outside the complied code of an application program that provides call flow instructions which direct the functional operation of the IVR system.

As the application program executes and reaches a point that requires a voice prompt, it selects a record of the database by passing a metalanguage variable first to an assignment table that is also held outside the compiled code of the application program. The assignment table assigns a particular value to the metalanguage variable. This value specifies an entry point into the database for recalling a database record which contains the desired voice prompt.

For example, to greet a telephone caller, the application program might request the voice prompt associated with the metalanguage variable m.greet. The assignment table might contain the assignment m.greet=2, which identifies the second voice prompt in the database (perhaps a customer greeting in English). The second voice prompt is then retrieved from the database and spoken by the IVR system.

So, according to the invention, an IVR system administrator who wishes to change the nature of a voice prompt such as a greeting need edit only the assignment table to reassign the value of the variable that specifies the entry point to the database, rather than alter and re-compile the application program. For example, to cause the IVR system to speak a different greeting, for example a greeting in Spanish, the administrator might edit the assignment table to change the assignment to m.greet=3, which would cause the IVR system to speak the third voice prompt (a greeting in Spanish) rather than the second voice prompt (the greeting in English).

In effect, the metalanguage conveys the purpose or thought or function of the voice prompt, but in a form that is disassociated from the linguistic attributes of the voice prompt. Disassociation enables a single metalanguage representation to be readily associated with a subset of the voice prompts in the database, wherein the members of the subset have the specific linguistic characteristics desired at the moment by the administrator. Thus, the present invention provides a convenient way of changing the linguistic characteristics of the voice prompts without requiring special IVR system programming skill. These and other aspects of the present invention will be more fully appreciated when considered in the light of the following detailed description and drawings.

### BRIEF DESCRIPTION OF THE DRAWINGS

FIG. 1 is a block diagram that shows aspects of an interactive voice response system according to the present invention.

FIG. 2 is a flowchart that shows aspects of the operation of the interactive voice response system of FIG. 1.

### DETAILED DESCRIPTION

In a conventional IVR system, voice prompts are internal to the application program that provides the call flow instructions which direct the operation of the IVR system. That is, voice prompts are referred to specifically by number or other particular alphanumeric identifier in the application program. So, when a voice prompt needs to be changed, a programmer must open the application program, change the identifier, and recompile the program. Such an IVR system is described in U.S. Pat. Nos. 5,479,487, “Calling center employing unified control system,” and 6,173,437, “Multimedia scripting tool.” In addition to providing a thorough description of an IVR system, these patents also teach ways of creating appropriate call flow instructions. U. S. Pat. Nos. 5,479,487 and 6,173,437 are hereby incorporated herein by reference.

In contrast, the present invention differs from the conventional IVR systems described in the above-incorporated United States patents in that an IVR system according to the present invention holds the voice prompts in a database outside the compiled code of the application program. When a call flow instruction requires a spoken prompt, the application program passes a metalanguage variable to an assignment table that is also held outside the complied code. The assignment table assigns a particular value to the variable, which value then serves as an entry point into the database. Consequently, to change the voice prompt associated with a particular call flow instruction, an administrator need change only the particular value within the assignment table. Thus, the present invention provides a convenient way of changing IVR system voice prompts without requiring special programming skill.

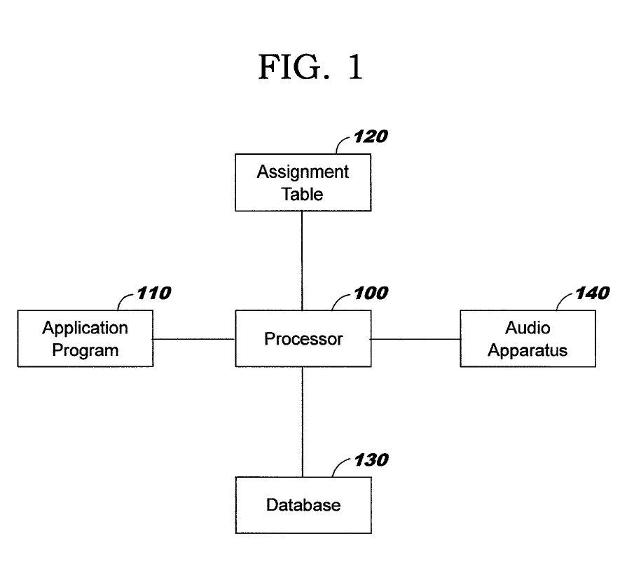

FIG. 1 shows an exemplary structure suitable for the present invention. A programmable processor 100 controls the execution and operation of an application program 110 that provides call flow instructions, which direct the functional operation of the IVR system; an assignment table 120, which holds specific values of variables provided by the application program 110; a database 130, which holds a plurality of pre-recorded voice prompts in digital form; and audio apparatus 140, which provides digital-to-analog conversion of pre-recorded voice prompts read from the database 130.

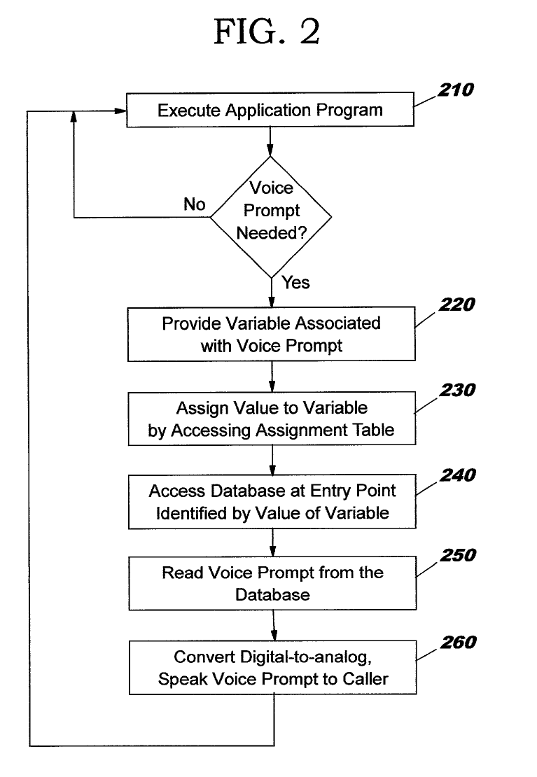

FIG. 2 shows aspects of the operation of an IVR system according to the present invention. As shown in FIG. 2, the processor 100 executes the application program 110 according to call flow instructions responsive to the needs and commands of a telephone caller (step 210). When a voice prompt is needed, the application program 110 provides a metalanguage variable that identifies the function of the voice prompt (step 220). The assignment table 120 is then accessed in accord with the variable, thereby to assign a specific value to the variable (step 230). The database 130 of pre-recorded voice prompts is accessed at the entry point specified by the specific value of the variable (step 240), and the desired voice prompt, which is held in the database 130 as a digitally encoded audio signal, is read from the database (step 250). The voice prompt is passed to the audio apparatus 140, which provides the necessary digital-to-analog conversion of the voice prompt, and speaks voice the prompt to the telephone caller (step 260). When interpreting the scope of the present invention, the terms “speech” and “voice prompt” are to be taken broadly, as these terms are intended here to encompass all kinds of audio signals, specifically including music, tones such as “beeps,” and sequences of tones, as well as spoken or synthesized words. Consequently, the voice prompts held in the database 130 may include musical components, tones, and sequences of tones as well.

For example, the application program 110 could provide call flow instructions for a banking application. The call flow instructions may specify that the first voice prompt heard by a telephone caller be a greeting. In the database 130 there could be a number of pre-recorded, digitally encoded voice prompts that provide greetings in different languages, with different degrees of formality, spoken by male and female speakers, and so forth. Each could be associated with an entry point to the database 130, for example a record number.

In the exemplary IVR system, the first record of the database 130 might include a formal greeting by a male speaker in the English language. The second record of the database 130 might include an informal greeting by a female speaker in the English language. The third record might include an informal greeting by a female speaker in the Spanish language. The fourth record might include a formal greeting by a male speaker in the Spanish language, and so forth.

When the application program 110 called for the first voice prompt, the application program 110 would provide the metalanguage variable m.greet. The assignment table 120 might assign the variable m.greet a value m.greet=3, which would specify, according to the foregoing exemplary list of greetings held in the database 130, an informal greeting in Spanish by a female speaker. The value m.greet=3 would be used as the entry point to the database 130, wherein the desired greeting was stored. The database 130 would provide, to the audio apparatus 140, a bit pattern representing the digitally encoded speech of the informal greeting in Spanish by a female speaker. The audio apparatus 140 would convert the bit pattern to an analog signal, which the audio apparatus 140 would provide to the telephone caller.

To change the greeting, a system administrator would need edit only the assignment table 120. For example, to change from the informal greeting in Spanish by a female speaker to a formal greeting in English by a male speaker, the administrator would change the assignment in the assignment table 120 from m.greet=3 to m.greet=1.

From the foregoing description, those skilled in the art will recognize that the present invention provides a convenient and economic way of tailoring the voice prompts of an interactive voice response (IVR) system, where the specialized skill of an IVR system programmer is not needed. The foregoing description is illustrative rather than limiting, however, and the present invention is limited only by the following claims.

We claim:

1. An interactive voice response system, comprising:
an application program that provides call flow instructions, wherein a call flow instruction that invokes a voice prompt provides a variable that can be read from outside complied code of the application program;
a programmable processor that executes the call flow instructions of the application program;
a database that contains a plurality of pre-recorded voice prompts; and
an assignment table that assigns a value to the variable to provide an entry point to the database.

2. The interactive voice response system of claim 1, wherein the database includes a first voice prompt in a first language and a second voice prompt in a second language, wherein the first language and the second language are different.

3. The interactive voice response system of claim 1, wherein the database includes a first voice prompt spoken by a first speaker and a second voice prompt spoken by a second speaker, wherein the first speaker and the second speaker are different.

4. The interactive voice response system of claim 1, wherein the database includes a first voice prompt spoken by a male speaker and a second voice prompt spoken by a female speaker.

5. The interactive voice response system of claim 1, wherein the database includes a first voice prompt having a first level of formality and a second voice prompt having a second level of formality, wherein the first level of formality and the second level of formality are different.

6. The interactive voice response system of claim 1, wherein the database includes a voice prompt that includes music.

7. The interactive voice response system of claim 1, wherein the database includes a voice prompt that includes an audio tone.

8. The interactive voice response system of claim 1, wherein the database includes a first voice prompt and a second voice prompt spoken by the same speaker, wherein the first voice prompt and the second voice prompt convey substantially the same meaning, and wherein the first voice prompt and the second voice prompt differ in wording.

9. A method for selecting a voice prompt of an interactive voice response system that operates according to the compiled code of an application program that provides call flow instructions for the interactive voice response system, the method comprising the steps of:
providing a variable associated with the voice prompt by the application program;
assigning a value to the variable by accessing an assignment table that is held outside the compiled code of the application program; and
reading a database record that includes a digitally encoded voice prompt, wherein the database record is identified by the value assigned to the variable.

10. The method of claim 9, wherein the database includes a first voice prompt in a first language and a second voice prompt in a second language, wherein the first language and the second language are different.

11. The method of claim 9, wherein the database includes a first voice prompt spoken by a first speaker and a second voice prompt spoken by a second speaker, wherein the first speaker and the second speaker are different.

12. The method of claim 9, wherein the database includes a first voice prompt spoken by a male speaker and a second voice prompt spoken by a female speaker.

13. The method of claim 9, wherein the database includes a first voice prompt having a first level of formality and a second voice prompt having a second level of formality, wherein the first level of formality and the second level of formality are different.

14. The method of claim 9, wherein the database includes a voice prompt that includes music.

15. The method of claim 9, wherein the database includes a voice prompt that includes an audio tone.

16. The method of claim 9, wherein the database includes a first voice prompt and a second voice prompt spoken by the same speaker, wherein the first voice prompt and the second voice prompt convey substantially the same meaning, and wherein the first voice prompt and the second voice prompt differ in wording.
